(19) United States
(12) Patent Application Publication
(10) Pub. No.: US 2025/0111472 A1
(43) Pub. Date: Apr. 3, 2025

(54) ADJUSTING THE ZOOM LEVEL OF CONTENT

(71) Applicant: Apple Inc., Cupertino, CA (US)

(72) Inventors: Gregory LUTTER, Boulder Creek, CA (US); Ioana NEGOITA, Mountain View, CA (US); Thomas G. SALTER, San Francisco, CA (US)

(21) Appl. No.: 18/900,282

(22) Filed: Sep. 27, 2024

Related U.S. Application Data
(60) Provisional application No. 63/586,609, filed on Sep. 29, 2023.

(51) Int. Cl. G06T 3/40; G06F 3/01; G06T 19/20

(52) U.S. Cl. CPC G06T 3/40; G06F 3/012; G06F 3/013; G06T 19/20; G06T 2219/2016

(57) ABSTRACT

Some examples of the disclosure are directed to systems and methods for changing a level of zoom of displayed content. In some examples, an electronic device displays visual content. In some examples, in response to detecting a change in position and/or orientation of the user of the electronic device, in accordance with a determination that the position and/or orientation of the user satisfies the one or more criteria, the electronic device increases the size of the content and/or zooms in on the content.

### CROSS-REFERENCE TO RELATED APPLICATIONS

This application claims the benefit of U.S. Provisional Patent Application No. 63/586,609, filed Sep. 29, 2023, the content of which is hereby incorporated by reference in its entirety for all purposes.

### FIELD OF THE DISCLOSURE

This relates generally to systems and methods of presenting content with an electronic device and, more particularly, to adjusting the level of zoom of the content based on detecting position and/or orientation of the user of the electronic device.

### BACKGROUND OF THE DISCLOSURE

Some computer graphical environments provide two-dimensional and/or three-dimensional environments where at least some objects presented for a user's viewing are virtual and generated by a computer. In some examples, the electronic device zooms in or out on one or more virtual objects.

### SUMMARY OF THE DISCLOSURE

This relates generally to systems and methods of presenting content with an electronic device and, more particularly, to adjusting the level of zoom of the content based on the position and/or orientation of the user of the electronic device. In some examples, the electronic device changes a level of zoom of visual content based on the position and/or orientation of the user. For example, the electronic device senses the position and/or orientation of the user as a way to approximate the posture of the user to change the level of zoom in response to the user changing their posture. In some embodiments, in response to detecting the position and/or orientation of the user satisfies one or more criteria, the electronic device increases the zoom level of the visual content.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIGS. 3A-3H illustrate ways an electronic device changes the zoom level of visual content based on the position and/or orientation of a user of the electronic device according to some examples of the disclosure.

FIG. 4 is a flowchart of a method of adjusting the zoom of visual content based on the position and/or orientation of a user of an electronic device according to some examples of the disclosure.

### DETAILED DESCRIPTION

This relates generally to systems and methods of presenting content with an electronic device and, more particularly, to adjusting the level of zoom of the content based on the position and/or orientation of the user of the electronic device. In some examples, the electronic device changes a level of zoom of visual content based on the position and/or orientation of the user. For example, the electronic device senses the position and/or orientation of the user as a way to approximate the posture of the user to change the level of zoom in response to the user changing their posture. In some embodiments, in response to detecting the position and/or orientation of the user satisfies one or more criteria, the electronic device increases the zoom level of the visual content.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

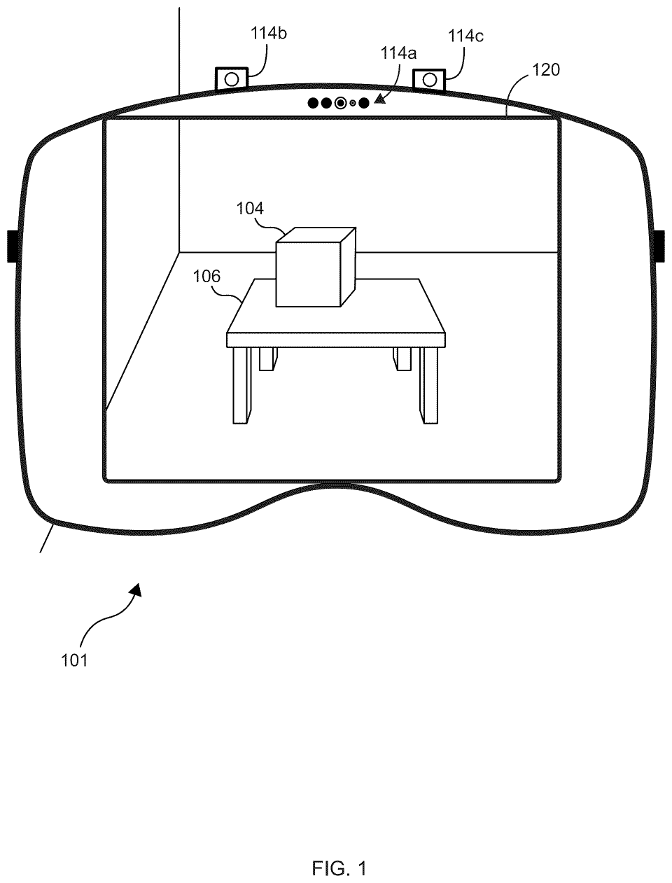

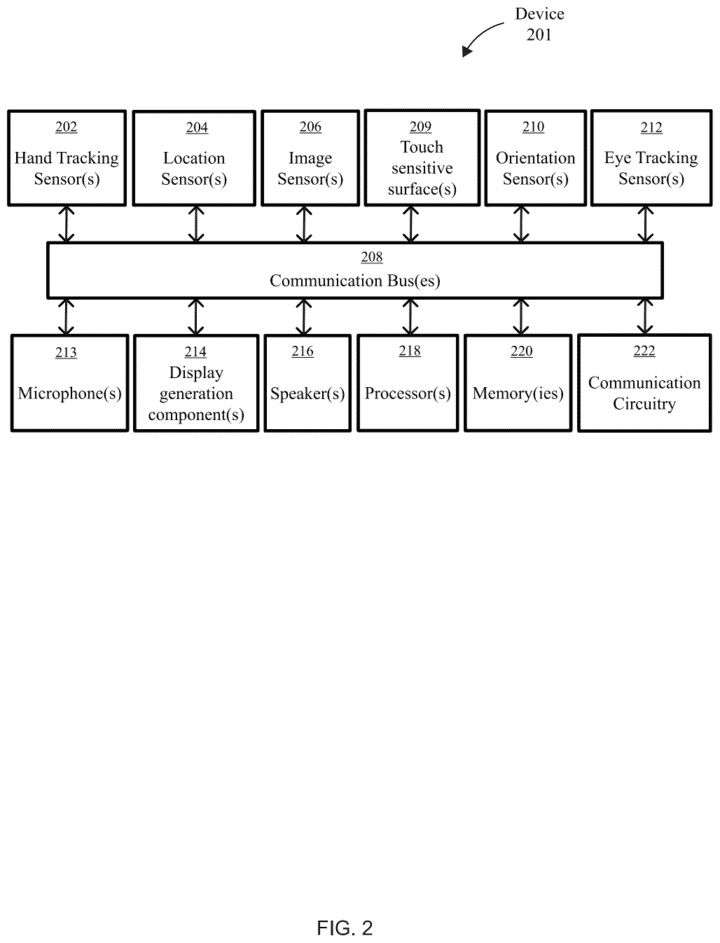

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120a to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120a has a field of view visible to the user (e.g., that may or may not correspond to a field of view of external image sensors 114b and 114c). Because display 120a is optionally part of a head-mounted device, the field of view of display 120a is optionally the same as or similar to the field of view of the user's eyes. In other examples, the field of view of display 120a may be smaller than the field of view of the user's eyes. In some examples, electronic device 101 may be an optical see-through device in which display 120a is a transparent or translucent display through which portions of the physical environment may be directly viewed. In some examples, display 120a may be included within a transparent lens and may overlap all or only a portion of the transparent lens. In other examples, electronic device may be a video-passthrough device in which display 120a is an opaque display configured to display images of the physical environment captured by external image sensors 114b and 114c.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120a of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120a in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hand, leg, torso, or head of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

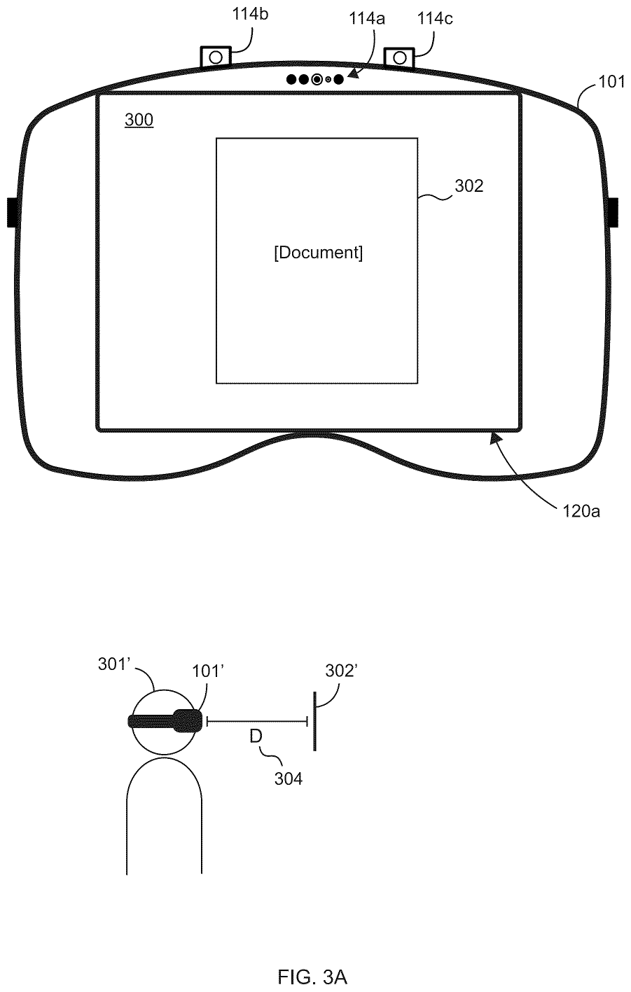

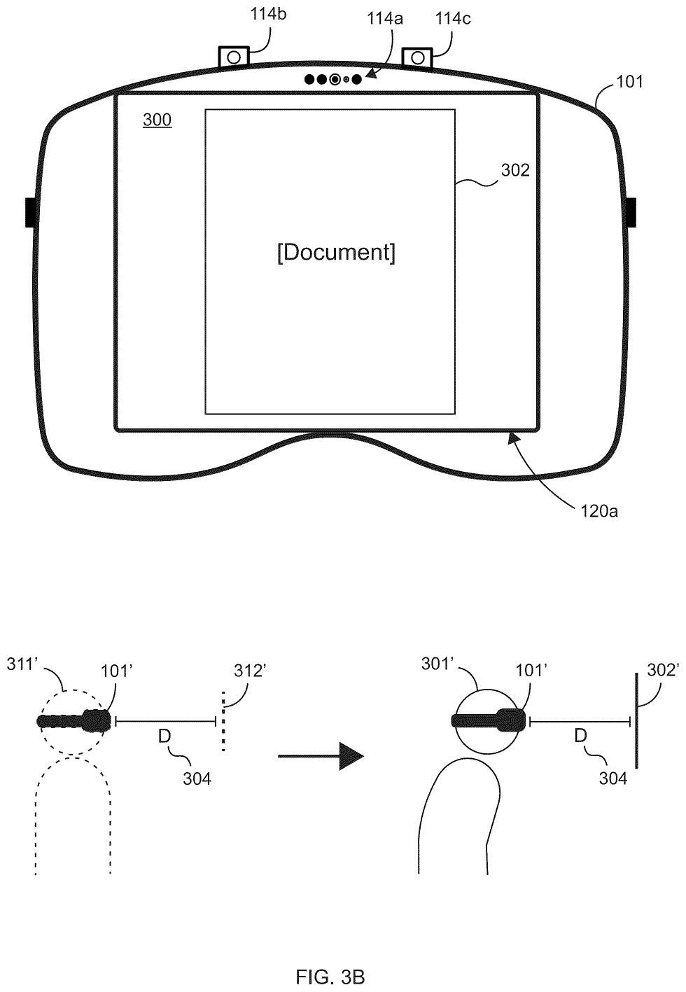

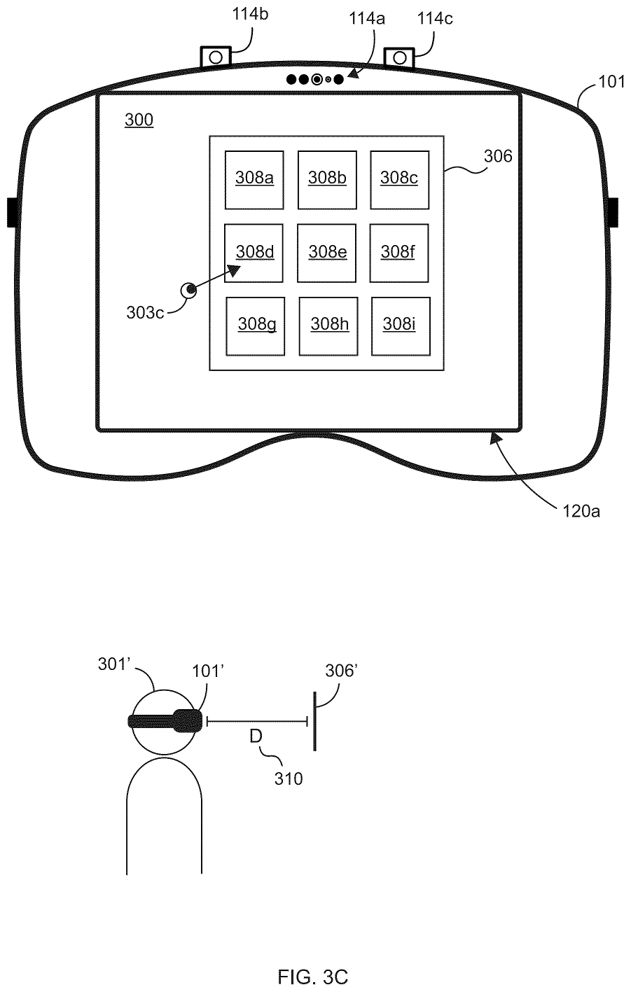

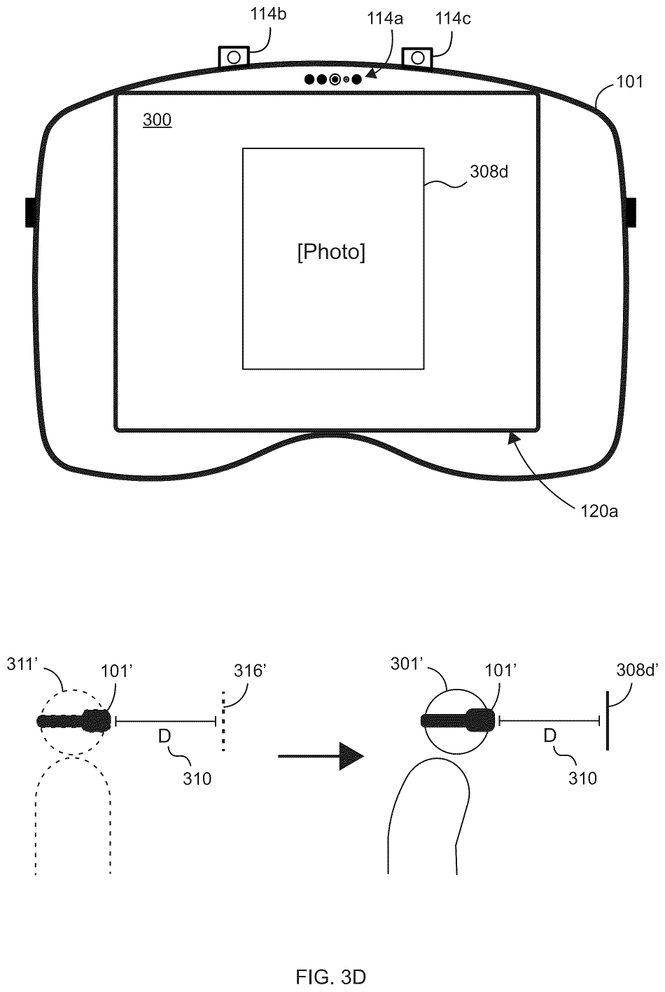

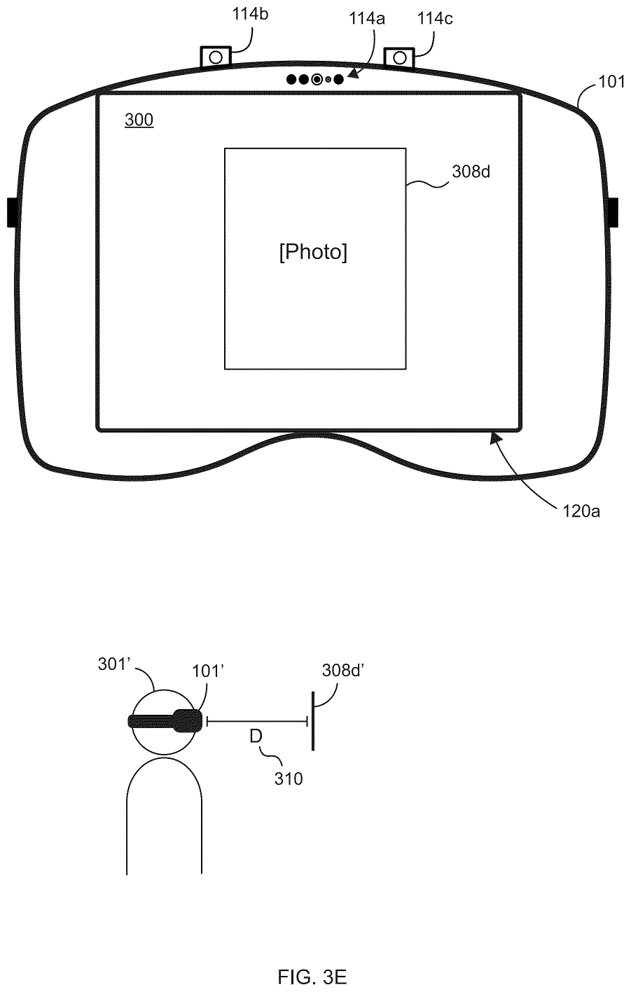

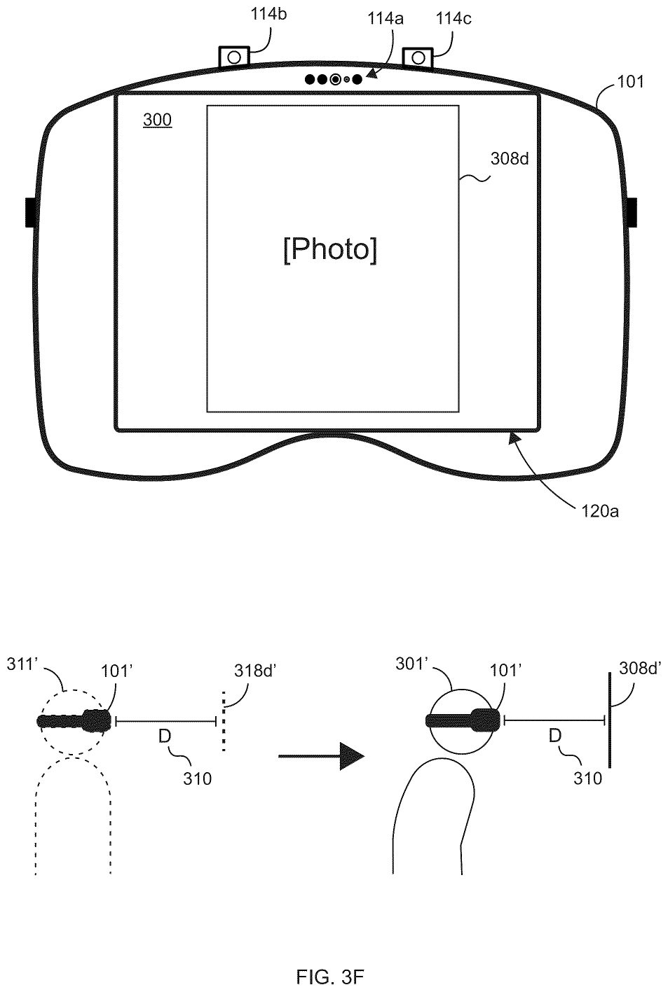

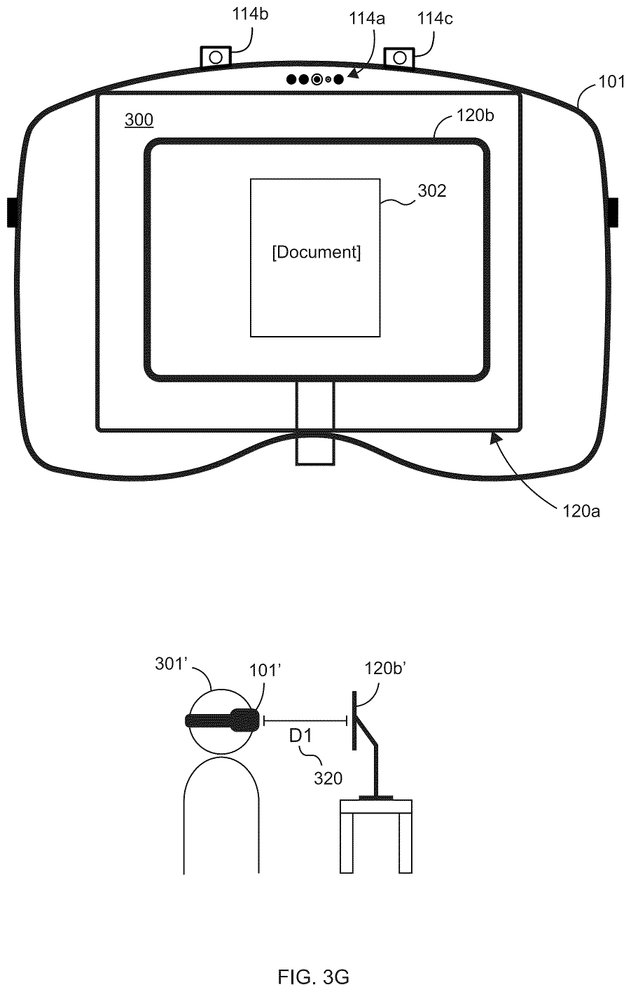

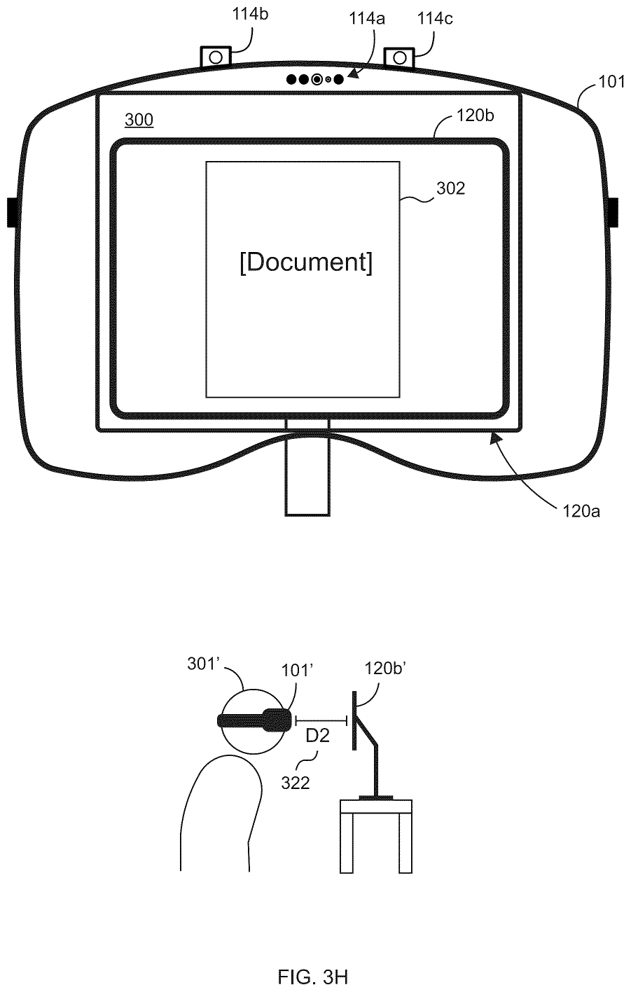

FIGS. 3A-3H illustrate ways an electronic device 101 changes the zoom level of visual content based on the position and/or orientation of a user of the electronic device according to some examples of the disclosure. In some examples, the electronic device 101 is of the same architecture as the electronic device 101 described above with reference to FIG. 1 and/or of the same architecture as the electronic device 201 described above with reference to FIG. 2.

FIG. 3A is an example of the electronic device 101 displaying visual content 302 using display 120a. In some examples, display 120a is configured to display three-dimensional content, such as displaying three-dimensional environments. In some examples, the electronic device 101 displays virtual content in the three-dimensional environment 300, including three-dimensional virtual objects and/or two-dimensional virtual objects. In some examples, the three-dimensional nature of the display 120a enables the electronic device 101 to display the visual content 302 at various depths in the three-dimensional environment 300.

In some examples, visual content 302 is a document including text and/or images. In some examples, the visual content 302 is a different type of content, such as video content; an image; and/or a user interface of an application such as a gaming application, an internet browsing application, a communication application, an audio content application, and/or a word processing application. In some examples, the visual content 302 is two-dimensional content displayed at a three-dimensional location in the three-dimensional environment 300. In some examples, the visual content 302 is three-dimensional content.

FIG. 3A further includes a representation of a side view of the user 301′ of the electronic device 101′ viewing the content item 302. For example, while the electronic device 101 displays the visual content 302 as shown in FIG. 3A, the user 301′ of the electronic device 101 has position and/or orientation that does not satisfy one or more criteria. For example, the user 301′ is standing or sitting upright and/or not leaning forward and/or not leaning forward by at least a threshold amount. In the example of FIG. 3A, the electronic device 101′ displays the visual content 302′ a distance D 304 from the viewpoint of the user 301′ in the three-dimensional environment 300.

In FIG. 3B, the electronic device 101 detects a change in the position and/or orientation of the user that corresponds to the posture of the user 301′ change from the position and/or orientation shown in FIG. 3A to a position and/or orientation that satisfies one or more criteria. For example, as shown in FIG. 3B, the position and/or orientation of the user 301′ satisfies the one or more criteria when the user is leaning forward. To illustrate the difference between the position and/or orientation of the user 301′ in FIG. 3A and the position and/or orientation of the user 301′ in FIG. 3B, FIG. 3B includes a representation of the user 311′ viewing the visual content 312′ with the position and/or orientation shown in FIG. 3A.

In some examples, as mentioned above, the position and/or orientation of the user 301′ satisfies one of the criteria of the one or more criteria when the position and/or orientation of the user corresponds to the user leaning forward. In some examples, the one or more criteria include a criterion that is satisfied when the user 301′ leans forward by at least a threshold amount (e.g., 5, 10, 20, 30, or 50 centimeters or 1, 2, 5, 10, or 15 degrees). In some examples, if the user 301′ leans forward by less than the threshold amount, then the one or more criteria are not satisfied. In some examples, the one or more criteria require detecting a change in altitude of the head of the user 301′ by at least a threshold amount (e.g., 1, 2, 3, 5, 10, or 20 centimeters). For example, the electronic device 101 includes an altimeter that detects the altitude of the electronic device 101 and, when the user wears the electronic device 101 on their head, in the case of a head-mounted device and/or a head-mounted display, then the altimeter measures the changes in altitude of the user's head. As another example, the electronic device 101 detects the change in altitude using one or more cameras and one or more computer vision algorithms. As another example, the electronic device 101 detects the change in altitude using an inertial measurement unit (IMU). In some examples, if the change in position and/or orientation does not change the altitude of the head of the user 301′ by the threshold amount, then the one or more criteria are not satisfied. In some examples, the electronic device detects movement of the user's head forward and/or backwards relative to the user's hips and/or torso. The electronic device can evaluate this detected movement against one or more criteria to determine whether the position and/or orientation of the user after the movement satisfies the one or more criteria. In some examples, the electronic device measures movement of the user (e.g., movement of the user's head) using an IMU, one or more cameras, and/or one or more depth sensors.

In some examples, it can be challenging to detect the user leaning forward while the user is walking or running. Thus, in some examples, when the electronic device 101 detects movement that corresponds to the user running or walking, the electronic device 101 deactivates the feature of changing the amount of zoom based on the position and/or orientation of the user. For example, the one or more criteria include a criterion that is satisfied when the user is not running or walking based on motion data of the electronic device. For example, the feature is not deactivated when the user is moving due to movement of a vehicle (e.g., riding in a moving vehicle as a passenger). As another example, the one or more criteria include a criterion that is satisfied when the user is stationary within a threshold speed or distance other than the leaning forward. In some examples, the electronic device 101 uses machine learning algorithms and/or techniques to classify the movement of the device as indicative of the user leaning forward or not indicative of the user leaning forward. For example, the electronic device 101 trains the machine learning algorithm using motion data collected while a user leans forward and motion data collected while the device is in motion other than the user leaning forward.

As shown in FIG. 3B, in response to detecting the position and/or orientation of the user 301′ change to a position and/or orientation that satisfies the one or more criteria (e.g., leaning forward), the electronic device 101 zooms in on the visual content 302. Zooming in on the visual content 302 optionally includes displaying the visual content 302 at a larger size than the size shown in FIG. 3A. In some examples, zooming in on the visual content 302 includes increasing the size of the visual content 302 in the three-dimensional environment 300. For example, the height of visual content 312′ is less than the height of visual content 302′ in FIG. 3B, representing the size of visual content 302 being greater in FIG. 3B than the size of visual content 302 in FIG. 3A. In other examples, the electronic device 101 maintains the size of the visual content 302 in the three-dimensional environment 300 and increases a size of a portion of the visual content 302 centered around the user's gaze within the original boundaries of the visual content 302. For example, if the user is looking at a top portion of the visual content 302 when they lean forward, the electronic device 101 increases the size of a portion of the visual content 302 including the top portion of the visual content while maintaining the boundaries of the visual content 302, optionally cropping other portions of the visual content 302 as needed. As another example, if the user is looking at a bottom portion of the visual content 302 when they lean forward, the electronic device 101 increases the size of a portion of the visual content 302 including the bottom portion of the visual content while maintaining the boundaries of the visual content 302, optionally cropping other portions of the visual content 302 as needed. In some examples, as shown in FIG. 3B, the electronic device 101 maintains display of the entirety of the visual content 302 when zooming in on the visual content 302. In some examples, although the electronic device maintains display of the entirety of the visual content 302 when zooming in, portions of the visual content 302 may not be visible to the user if they are beyond the user's field of view into the three-dimensional environment 300. In these situations, it is possible for the user to turn their head to change the portion of the visual content 302 that is within the user's field of view, for example.

In some examples, the electronic device 101 zooms in on the visual content 302 by a fixed amount in response to detecting that the position and/or orientation of the user 301′ satisfies the one or more criteria, regardless of how much the user leans forward past the threshold amount. In some examples, the electronic device 101 zooms in on the visual content 302 by an amount corresponding to the amount by which the user 301′ leans forward at or past the threshold amount. For example, if the user 301′ leans forward by a relatively large amount (e.g., greater than a threshold), the electronic device 101 zooms in on the visual content 302 more than the amount the electronic device 101 zooms in on the visual content 302 in response to the user 301′ leaning forward by a relatively small amount (e.g., less than a threshold).

As shown in FIG. 3B, when the electronic device 101 zooms in on the visual content 302, the electronic device 101 also updates the position of the visual content 302′ in the three-dimensional environment 300 to maintain the distance 304 between the viewpoint of the user 301′ and the visual content 302′. For example, the distance 304 at which the electronic device 101 displays the visual content 302′ from the viewpoint of the user 301′ while zooming in on the visual content 302 is the same as the distance 304 at which the electronic device 101 displays the visual content 312′ from the viewpoint of the user 311′ without zooming in on the visual content 302. In some examples, the electronic device 101 maintains distance 304 by gradually moving the visual content 302′ away from the viewpoint of the user in the depth dimension of the three-dimensional environment 300 while increasing the zoom of the visual content 302 in response to detecting the position and/or orientation of the user 301′ that satisfies the one or more criteria. In some examples, in response to the user leaning forward by less than the threshold amount, the electronic device 101 does not update the position of the visual content 302 in the three-dimensional environment 300 and does not update the size of the visual content 302, either. Maintaining the distance D 304 between the viewpoint of the user 301′ and the visual content 302′ when zooming in on the visual content 302 enhances user interactions with the electronic device 101 by reducing eye strain and increasing user comfort.

In some examples, while the electronic device 101 displays the visual content 302 zoomed in as shown in FIG. 3B, the electronic device 101 detects the user's position and/or orientation return to a position and/or orientation that does not satisfy the one or more criteria. For example, the electronic device 101 detects the user return to sitting/standing straight, leaning forward by less than the threshold amount described above, or leaning backwards. In some examples, in response to detecting the position and/or orientation of the user that does not satisfy the one or more criteria while displaying the visual content 302 zoomed in, the electronic device 101 zooms the visual content 302 out. For example, the electronic device 101 returns the level of zoom to the level shown in FIG. 3A, to a level between the level of zoom shown in FIG. 3A and the level of zoom shown in FIG. 3B, or to a level of zoom that is zoomed out from the level shown in FIG. 3A.

In some examples, the electronic device 101 maintains the level of zoom shown in FIG. 3B in response to detecting the user's position and/or orientation change to not satisfying the one or more criteria as described above. In these examples, in response to detecting the user's position and/or orientation satisfy the one or more criteria again after displaying the zoomed-in visual content 302 while the user's position and/or orientation did not satisfy the one or more criteria, the electronic device 101 increases the level of zoom of the visual content 302 again. In this way, the electronic device 101 increases the level of zoom each time the electronic device 101 detects the position and/or orientation of the user satisfy the one or more criteria. In some examples, the electronic device 101 reduces the level of zoom in response to receiving an input that is different from detecting a change in the position and/or orientation of the user. For example, the input is one or more of an input received using a hardware input device; an input that includes detecting an air gesture performed with a finger, hand, and/or arm of the user; an input that includes detecting the gaze of the user; and/or a voice command.

FIG. 3C illustrates the electronic device 101 displaying a gallery 306 of a plurality of items of visual content 308a through 308i according to some examples of the disclosure. For example, the items of visual content 308a through 308i are thumbnail-sized representations of images, such as photographs, videos, animations, and/or drawings. In some examples, the items of visual content 308a through 308i correspond to other types of visual content. For example, items of visual content 308a through 308i are thumbnail images and/or blocks of text representing documents; articles; audio content such as music, audiobooks, and/or podcasts; websites; and/or application user interfaces. As shown in FIG. 3C, the electronic device 101 displays the gallery 306′ a distance D 310 from the viewpoint of the user 301′ in the three-dimensional environment 300.

In some examples, in response to detecting that the user's position and/or orientation satisfies the one or more criteria while the user is looking at a respective item of visual content 308a through 308i, the electronic device 101 displays a larger representation corresponding to the item of visual content at which the user was looking. For example, in FIG. 3C, the electronic device 101 detects the user's gaze 303c directed to visual content 308d. In some examples, the electronic device 101 detects the location of the user's gaze 303c using camera(s) and/or other types of eye-tracking devices.

FIG. 3D illustrates an example of the electronic device 101 displaying a zoomed-in version of visual content 308d in accordance with some examples of the disclosure. For example, the electronic device 101 displays the zoomed-in version of the visual content 308d in response to detecting gaze 303c of the user directed to visual content 308d in FIG. 3C while detecting the position and/or orientation of the user satisfies the one or more criteria. For example, FIG. 3D illustrates a transition from the position and/or orientation of the user 311′ not satisfying the one or more criteria to the position and/or orientation of the user 301′ satisfying the one or more criteria.

In some examples, the visual content 308d in FIG. 3D has the same contents as the visual content 308d in FIG. 3C, but is displayed at a larger size in the three-dimensional environment 300. In some examples, the visual content 308d in FIG. 3D has different and/or additional content to the visual content 308d in FIG. 3C. In some examples, the visual content 308d in FIG. 3D may have the same dimensions in three-dimensional environment 300 as gallery 306 in FIG. 3C. In other examples, the visual content 308d in FIG. 3D may have different dimensions in three-dimensional environment 300 than gallery 306 in FIG. 3C. In some examples, the electronic device 101 displays the visual content 308d′ at the same distance D 310 from the viewpoint of the user 301′ as the distance D 310 between the gallery 316′ and the viewpoint of the user 311′ from FIG. 3C. In some examples, as shown in FIG. 3D, the electronic device 101 ceases display of gallery 306 and the other items of visual content 308a through 308c and 308e through 308i from FIG. 3C when displaying the visual content 308d zoomed in in FIG. 3D. In some examples, the electronic device 101 maintains display of one or more of gallery 306 and/or the other items of visual content 308a through 308c and 308e through 308i when displaying the visual content 308d zoomed in, but does not zoom in on or increase the size of gallery 306 in the three-dimensional environment 300 and/or the other items of visual content 308a through 308c and 308e through 308i when displaying the visual content 308d zoomed in. In some examples, if the user had looked at a different item of visual content 308a through 308c and/or 308e through 308i when the position and/or orientation of the user satisfied the one or more criteria, then the electronic device 101 would zoom in on the item of visual content 308a through 308c and 308e through 308i the user was looking at when the position and/or orientation of the use satisfied the one or more criteria in response to detecting the position and/or orientation of the use satisfying the one or more criteria.

FIG. 3E illustrates the electronic device 101 continuing to display the visual content 308d at the zoom level of FIG. 3D while detecting that the position and/or orientation of the user 301′ does not satisfy the one or more criteria according to some examples of the disclosure. As shown in FIG. 3E, the electronic device 101 maintains the distance D 310 between the viewpoint of the user 301′ and the visual content 308d′ in FIG. 3D. In some examples, maintaining distance D 310 includes adjusting the position of the visual content 308d′ in the direction the head of the user 301′ moves. For example, when the user's head moves forward in FIG. 3D, the electronic device 101 moves the visual content 308d′ away from the user in the three-dimensional environment 300 and when the user's head moves backwards from FIG. 3D to FIG. 3E, the electronic device 101 moves the visual content 308d′ towards the user in the three-dimensional environment 300.

Alternatively, in some examples, in response to detecting that the position and/or orientation of the user does not satisfy the one or more criteria while displaying the visual content 308d at the level of zoom shown in FIG. 3E, the electronic device 101 displays the gallery 306 and items of visual content 308a through 308i shown in FIG. 3C.

In some examples, if the electronic device 101 detects the user's position and/or orientation satisfy the one or more criteria while displaying the visual content 308d zoomed in as shown in FIG. 3E, the electronic device 101 zooms the visual content 308d in further, as shown in FIG. 3F.

FIG. 3F illustrates the electronic device 101 displaying the visual content 308d zoomed in compared to the level of zoom of the visual content 308d in FIG. 3E according to some examples of the disclosure. In some examples, increasing the zoom of visual content 308d is similar to other techniques described herein for zooming visual content in response to detecting the position and/or orientation of the user satisfy the one or more criteria. For example, the distance D 310 between the viewpoint of the user 311′ and the visual content 318d′ from FIG. 3E is the same as the distance D 310 between the viewpoint of the user 301′ and the visual content 308d′ in FIG. 3F. In some examples, the electronic device 101 increases the amount of zoom of the visual content 308d by an amount corresponding to the amount by which the user leans forward. In some examples, the electronic device 101 increases the amount of zoom of the visual content 308d by a predetermined amount irrespective of the amount by which the user leans forward.

In some examples, in response to detecting that the position and/or orientation of the user no longer satisfies the one or more criteria while displaying the visual content 308d at the level of zoom shown in FIG. 3F, the electronic device 101 navigates back to the user interface shown in FIG. 3C. In some examples, in response to detecting the that position and/or orientation of the user no longer satisfies the one or more criteria while displaying the visual content 308d at the level of zoom shown in FIG. 3F, the electronic device 101 displays the visual content 308d at the level of zoom shown in FIG. 3E. In some examples, in response to detecting that the position and/or orientation of the user no longer satisfies the one or more criteria while displaying the visual content 308d at the level of zoom shown in FIG. 3F, the electronic device 101 maintains the level of zoom of the visual content 308d and increases the amount of zoom in response to detecting the position and/or orientation of the user satisfying the one or more criteria again. In some examples, other types of inputs, including the types of inputs described above, are available to navigate back to the user interface shown in FIG. 3C and/or to adjust the zoom level of the visual content 308d.

FIG. 3G illustrates a physical display 120b in communication with the electronic device 101 displaying visual content 302 (e.g., a document) in accordance with some examples of the disclosure. In some examples, electronic device 101 controls the contents displayed by display 120d. Display 120d is optionally a two-dimensional display, such as a monitor, television screen, projector, or touch screen. In some examples, the user 301′ of the electronic device 101 is able to view visual content 302 displayed by display 120b through a transparent portion of display 120a. In some examples, display 120a displays a video representation of display 120b and the contents displayed by display 120b. In some examples, visual content 302 has one or more of the characteristics described above. As shown in FIG. 3G, the position and/or orientation of the user 301′ does not satisfy the one or more criteria (e.g., the user is sitting or standing up straight or leaning forward by less than a threshold amount).

In some examples, while display 120b displays visual content 302, in response to detecting that the user's position and/or orientation satisfies the one or more criteria, the electronic device 101 increases the level of zoom of visual content 302.

FIG. 3H illustrates the electronic device 101 displaying visual content 302 zoomed in compared to the amount of zoom in FIG. 3G in response to detecting the position and/or orientation of the user 301′ satisfying the one or more criteria in some examples of the disclosure. As shown in FIG. 3H, the position and/or orientation of the user 301′ satisfies the one or more criteria and the display 120b displays visual content 302 with increased zoom. In some examples, and as shown in FIG. 3H, zooming the visual content 302 in includes increasing the portion of the display 120b occupied by visual content 302. In other examples, zooming the visual content 302 in includes increasing the size of a portion of the visual content 302 to which the gaze of the user is directed while maintaining the size of the display 120b occupied by content 302, cropping other portions of the visual content 302 as needed, as described in more detail above.

In some examples, the distance D2 322 between the viewpoint of the user 301′ and the display 120b′ in FIG. 3H is less than the distance D1 320 between the viewpoint of the user 301′ and display 120b′. Thus, in some examples in which display 120b is a two-dimensional display fixed in space, the distance between the viewpoint of the user 301′ and the visual content 302 also decreases when the user leans in. In some examples, other than moving the visual content 302 towards and/or away from the user, the display 120b is capable of the other techniques described herein with respect to display 120a, such as zooming by amounts corresponding to the amount by which the user leans forward, zooming by a predetermined amount regardless of the amount by which the user leans forward, displaying a zoomed in version of an item of visual content selected from a gallery of visual content based on gaze, reducing zoom and/or navigating back in response to detecting the position and/or orientation of the use no longer satisfy the one or more criteria, and/or maintaining display of visual content at a respective zoom level when the position and/or orientation of the user does not satisfy the one or more criteria to allow for additional zooming in response to detecting the position and/or orientation of the user satisfy the one or more criteria again.

Thus, FIGS. 3A-3H illustrate examples of the electronic device 101 zooming in on visual content in response to detecting the user leaning forward. In some examples, the electronic device 101 similarly zooms out on visual content in response to detecting the user leaning backwards.

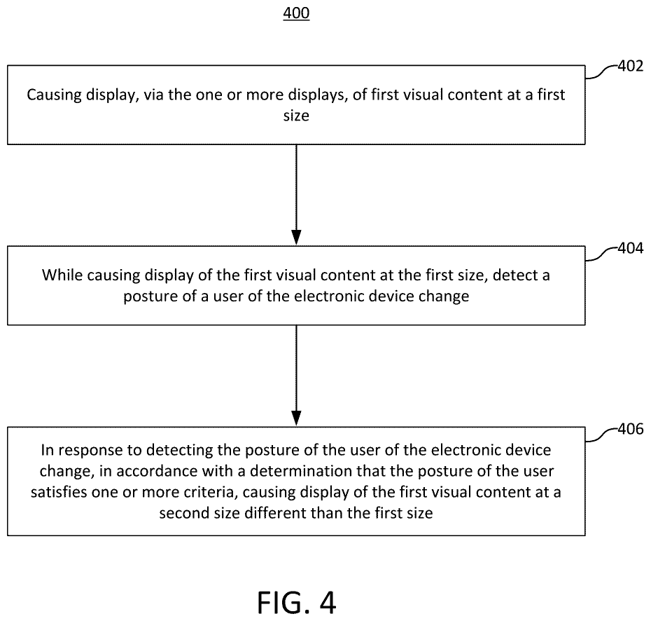

FIG. 4 is a flowchart of a method 400 of adjusting the zoom of visual content based on the position and/or orientation of a user of an electronic device according to some examples of the disclosure. In some examples, electronic device 101 and/or electronic device 201 performs method 400. In some examples, instructions for executing method 400 are stored on a computer readable storage medium and, when executed, cause electronic device 101 and/or electronic device 201 to perform method 400. Steps of method 400 are optionally repeated and/or skipped and/or the order of the steps of method 400 are optionally changed without departing from the scope of the disclosure.

At 402, method 400 optionally includes causing display, via the one or more displays, of first visual content at a first size. At 404, method 400 optionally includes, while causing display of the first visual content at the first size, detecting a position and/or orientation of a user of the electronic device change. At 406, method 400 optionally includes in response to detecting the position and/or orientation of the user of the electronic device change, in accordance with a determination that the position and/or orientation of the user satisfies one or more criteria, causing display of the first visual content at a second size different than the first size.

Additionally or alternatively, in some examples, the electronic device causes display of the first visual content in a three-dimensional environment, while causing display of the first visual content at the first size while the position and/or orientation of the user does not satisfy the one or more criteria, the electronic device causes display of the first visual content a first distance from a viewpoint of the user in the three-dimensional environment, and while causing display of the first visual content at the second size in accordance with the determination that the position and/or orientation of the user satisfies the one or more criteria, the electronic device causes display of the first visual content the first distance from the viewpoint of the user in the three-dimensional environment. Additionally or alternatively, in some examples, method 400 includes in response to detecting the position and/or orientation of the user change, in accordance with the determination that the position and/or orientation of the user satisfies the one or more criteria, the electronic device updates a position of the first visual content from a first position in the three-dimensional environment to a second position in the three-dimensional environment. Additionally or alternatively, in some examples, the first size of the visual content and the second size of the visual content are sizes in a three-dimensional environment relative to the three-dimensional environment. Additionally or alternatively, in some examples causing display of the first visual content at the second size includes causing display of an entirety of the first visual content that was displayed at the first size. Additionally or alternatively, in some examples causing display of the first visual content at the first size includes causing display of the first visual content at the first size concurrently with second visual content, and causing display of the first visual content at the second size includes causing display of the first visual content at the second size without causing display of the second visual content. Additionally or alternatively, in some examples method 400 includes prior to detecting the position and/or orientation of the user change, concurrently causing display of second visual content at a third size with the first visual content at the first size and in response to detecting the position and/or orientation of the user change, in accordance with the determination that the position and/or orientation of the user satisfies the one or more criteria: in accordance with a determination that a gaze of the user was directed to the first visual content while the position and/or orientation of the user changed, causing display of the first visual content at the second size and causing cessation of display of the second visual content; and in accordance with a determination that a gaze of the user was directed to the second visual content while the position and/or orientation of the user changed, causing display of the second visual content at a fourth size different than the third size and causing cessation of display of the first visual content. Additionally or alternatively, in some examples method 400 includes while causing display of the first visual content at the second size without causing display of the second visual content, detecting the position and/or orientation of the user change from satisfying the one or more criteria to not satisfying the one or more criteria; and in response to detecting the position and/or orientation of the user change from satisfying the one or more criteria to not satisfying the one or more criteria, causing display, via the one or more displays, of the first visual content at the first size concurrently with the second visual content. Additionally or alternatively, in some examples, method 400 includes while causing display of the first visual content at the second size without causing display of the second visual content, detecting the position and/or orientation of the user change from satisfying the one or more criteria to not satisfying the one or more criteria; in response to detecting the position and/or orientation of the user change from satisfying the one or more criteria to not satisfying the one or more criteria while causing display of the first visual content at the second size without causing display of the second visual content, causing display of the first visual content at the second size to be maintained without causing display of the second visual content; while maintaining display of the first visual content at the second size without causing display of the second visual content, detecting the position and/or orientation of the user change from not satisfying the one or more criteria to satisfying the one or more criteria; and in response to detecting the position and/or orientation of the user change from not satisfying the one or more criteria to satisfying the one or more criteria while maintaining display of the first visual content at the second size without causing display of the second visual content, causing display of the first visual content at a third size different than the second size without causing display of the second visual content. Additionally or alternatively, in some examples, method 400 includes while causing display of the first visual content at the second size, detecting the position and/or orientation of the user change from satisfying the one or more criteria to not satisfying the one or more criteria; and in response to detecting the position and/or orientation of the user change from satisfying the one or more criteria to not satisfying the one or more criteria, causing display of the first visual content at the first size. Additionally or alternatively, in some examples the one or more criteria include a criterion that is satisfied when the position and/or orientation of the user moves forward by at least a threshold amount, and wherein the second size is greater than the first size. Additionally or alternatively, in some examples the one or more criteria include a criterion that is satisfied when the position and/or orientation of the user moves backward by at least a threshold amount, and wherein the second size is less than the first size. Additionally or alternatively, in some examples the one or more criteria include a criterion that is satisfied when an altitude of a head of the user changes by at least a threshold amount. Additionally or alternatively, in some examples the one or more criteria include a criterion that is satisfied when the user is not walking or running. Additionally or alternatively, in some examples the electronic comprises a head-mounted device having the one or more displays, and wherein the electronic device is configured to cause display of the first visual content by displaying three-dimensional images using the one or more displays. Additionally or alternatively, in some examples the one or more displays are remote from the electronic device, and wherein the electronic device is configured to cause display of the first visual content by causing the one or more displays to display two-dimensional images. Additionally or alternatively, in some examples causing display of the first visual content at the first size includes causing display of the first visual content with a first scale, and causing display of the first visual content at a second size includes: in accordance with a determination that a gaze of the user was directed to a first portion of the first visual content while the position and/or orientation of the user of the electronic device changed, causing display of a portion of the first visual content including the first portion with a second scale different from the first scale; and in accordance with a determination that the gaze of the user was directed to a second portion of the first visual content different from the first portion while the position and/or orientation of the user of the electronic device changed, causing display of a portion of the first visual content including the second portion with the second scale different from the first scale. Additionally or alternatively, in some examples causing display of the portion of the first visual content including the first portion of the first visual content includes causing forgoing display of the second portion of the visual content and causing display of the portion of the second visual content including the first portion of the first visual content includes causing forgoing display of the first portion of the visual content. Additionally or alternatively, in some examples causing display of the portion of the first visual content including the first portion with the second scale includes occupying a first amount of space in a three-dimensional environment, and causing display of the portion of the first visual content including the second portion with the second scale includes occupying the first amount of space in a three-dimensional environment.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more displays:
causing display, via the one or more displays, of first visual content at a first size;
while causing display of the first visual content at the first size, detecting a position and/or orientation of a user of the electronic device change; and
in response to detecting the position and/or orientation of the user of the electronic device change, in accordance with a determination that the position and/or orientation of the user satisfies one or more criteria, causing display of the first visual content at a second size different than the first size.

2. The method of claim 1, wherein:
the electronic device causes display of the first visual content in a three-dimensional environment,
while causing display of the first visual content at the first size while the position and/or orientation of the user does not satisfy the one or more criteria, the electronic device causes display of the first visual content a first distance from a viewpoint of the user in the three-dimensional environment, and
while causing display of the first visual content at the second size in accordance with the determination that the position and/or orientation of the user satisfies the one or more criteria, the electronic device causes display of the first visual content the first distance from the viewpoint of the user in the three-dimensional environment.

3. The method of claim 1, wherein the first size of the first visual content and the second size of the first visual content are sizes in a three-dimensional environment relative to the three-dimensional environment.

4. The method of claim 1, wherein causing display of the first visual content at the first size includes causing display of the first visual content at the first size concurrently with second visual content, and causing display of the first visual content at the second size includes causing display of the first visual content at the second size without causing display of the second visual content.

5. The method of claim 1, further comprising:
prior to detecting the position and/or orientation of the user change, concurrently causing display of second visual content at a third size with the first visual content at the first size and;
in response to detecting the position and/or orientation of the user change, in accordance with the determination that the position and/or orientation of the user satisfies the one or more criteria:
in accordance with a determination that a gaze of the user was directed to the first visual content while the position and/or orientation of the user changed, causing display of the first visual content at the second size and causing cessation of display of the second visual content; and
in accordance with a determination that a gaze of the user was directed to the second visual content while the position and/or orientation of the user changed, causing display of the second visual content at a fourth size different than the third size and causing cessation of display of the first visual content.

6. The method of claim 1, further comprising:
while causing display of the first visual content at the second size, detecting the position and/or orientation of the user change from satisfying the one or more criteria to not satisfying the one or more criteria; and
in response to detecting the position and/or orientation of the user change from satisfying the one or more criteria to not satisfying the one or more criteria, causing display of the first visual content at the first size.

7. The method of claim 1, wherein the one or more criteria include a criterion that is satisfied when an altitude of a head of the user changes by at least a threshold amount.

8. The method of claim 1, wherein causing display of the first visual content at the first size includes causing display of the first visual content with a first scale, and causing display of the first visual content at the second size includes:
in accordance with a determination that a gaze of the user was directed to a first portion of the first visual content while the position and/or orientation of the user of the electronic device changed, causing display of a portion of the first visual content including the first portion with a second scale different from the first scale; and
in accordance with a determination that the gaze of the user was directed to a second portion of the first visual content different from the first portion while the position and/or orientation of the user of the electronic device changed, causing display of a portion of the first visual content including the second portion with the second scale different from the first scale.

9. An electronic device comprising:
memory;
one or more processors coupled to the memory and configured to perform a method comprising:
causing display, via one or more displays, of first visual content at a first size;
while causing display of the first visual content at the first size, detecting a position and/or orientation of a user of the electronic device change; and
in response to detecting the position and/or orientation of the user of the electronic device change, in accordance with a determination that the position and/or orientation of the user satisfies one or more criteria, causing display of the first visual content at a second size different than the first size.

10. The electronic device of claim 9, wherein:
the electronic device causes display of the first visual content in a three-dimensional environment,
while causing display of the first visual content at the first size while the position and/or orientation of the user does not satisfy the one or more criteria, the electronic device causes display of the first visual content a first distance from a viewpoint of the user in the three-dimensional environment, and
while causing display of the first visual content at the second size in accordance with the determination that the position and/or orientation of the user satisfies the one or more criteria, the electronic device causes display of the first visual content the first distance from the viewpoint of the user in the three-dimensional environment.

11. The electronic device of claim 9, wherein the first size of the first visual content and the second size of the first visual content are sizes in a three-dimensional environment relative to the three-dimensional environment.

12. The electronic device of claim 9, wherein causing display of the first visual content at the first size includes causing display of the first visual content at the first size concurrently with second visual content, and causing display of the first visual content at the second size includes causing display of the first visual content at the second size without causing display of the second visual content.

13. The electronic device of claim 9, wherein the method further comprises:
prior to detecting the position and/or orientation of the user change, concurrently causing display of second visual content at a third size with the first visual content at the first size and;
in response to detecting the position and/or orientation of the user change, in accordance with the determination that the position and/or orientation of the user satisfies the one or more criteria:
in accordance with a determination that a gaze of the user was directed to the first visual content while the position and/or orientation of the user changed, causing display of the first visual content at the second size and causing cessation of display of the second visual content; and
in accordance with a determination that a gaze of the user was directed to the second visual content while the position and/or orientation of the user changed, causing display of the second visual content at a fourth size different than the third size and causing cessation of display of the first visual content.

14. The electronic device of claim 9, wherein the method further comprises:
while causing display of the first visual content at the second size, detecting the position and/or orientation of the user change from satisfying the one or more criteria to not satisfying the one or more criteria; and
in response to detecting the position and/or orientation of the user change from satisfying the one or more criteria to not satisfying the one or more criteria, causing display of the first visual content at the first size.

15. The electronic device of claim 9, wherein the one or more criteria include a criterion that is satisfied when an altitude of a head of the user changes by at least a threshold amount.

16. The electronic device of claim 9, wherein causing display of the first visual content at the first size includes causing display of the first visual content with a first scale, and causing display of the first visual content at the second size includes:
in accordance with a determination that a gaze of the user was directed to a first portion of the first visual content while the position and/or orientation of the user of the electronic device changed, causing display of a portion of the first visual content including the first portion with a second scale different from the first scale; and
in accordance with a determination that the gaze of the user was directed to a second portion of the first visual content different from the first portion while the position and/or orientation of the user of the electronic device changed, causing display of a portion of the first visual content including the second portion with the second scale different from the first scale.

17. A non-transitory computer readable storage medium storing instructions, which, when executed by an electronic device with memory and one or more processors coupled to the memory causes the electronic device to perform a method comprising:
causing display, via one or more displays, of first visual content at a first size;
while causing display of the first visual content at the first size, detecting a position and/or orientation of a user of the electronic device change; and
in response to detecting the position and/or orientation of the user of the electronic device change, in accordance with a determination that the position and/or orientation of the user satisfies one or more criteria, causing display of the first visual content at a second size different than the first size.

18. The non-transitory computer readable storage medium of claim 17, wherein:
the electronic device causes display of the first visual content in a three-dimensional environment,
while causing display of the first visual content at the first size while the position and/or orientation of the user does not satisfy the one or more criteria, the electronic device causes display of the first visual content a first distance from a viewpoint of the user in the three-dimensional environment, and
while causing display of the first visual content at the second size in accordance with the determination that the position and/or orientation of the user satisfies the one or more criteria, the electronic device causes display of the first visual content the first distance from the viewpoint of the user in the three-dimensional environment.

19. The non-transitory computer readable storage medium of claim 17, wherein the first size of the first visual content and the second size of the first visual content are sizes in a three-dimensional environment relative to the three-dimensional environment.

20. The non-transitory computer readable storage medium of claim 17, wherein causing display of the first visual content at the first size includes causing display of the first visual content at the first size concurrently with second visual content, and causing display of the first visual content at the second size includes causing display of the first visual content at the second size without causing display of the second visual content.

21. The non-transitory computer readable storage medium of claim 17, wherein the method further comprises:
prior to detecting the position and/or orientation of the user change, concurrently causing display of second visual content at a third size with the first visual content at the first size and;
in response to detecting the position and/or orientation of the user change, in accordance with the determination that the position and/or orientation of the user satisfies the one or more criteria:
in accordance with a determination that a gaze of the user was directed to the first visual content while the position and/or orientation of the user changed, causing display of the first visual content at the second size and causing cessation of display of the second visual content; and
in accordance with a determination that a gaze of the user was directed to the second visual content while the position and/or orientation of the user changed, causing display of the second visual content at a fourth size different than the third size and causing cessation of display of the first visual content.

22. The non-transitory computer readable storage medium of claim 17, wherein the method further comprises:
while causing display of the first visual content at the second size, detecting the position and/or orientation of the user change from satisfying the one or more criteria to not satisfying the one or more criteria; and
in response to detecting the position and/or orientation of the user change from satisfying the one or more criteria to not satisfying the one or more criteria, causing display of the first visual content at the first size.

23. The non-transitory computer readable storage medium of claim 17, wherein the one or more criteria include a criterion that is satisfied when an altitude of a head of the user changes by at least a threshold amount.

24. The non-transitory computer readable storage medium of claim 17, wherein causing display of the first visual content at the first size includes causing display of the first visual content with a first scale, and causing display of the first visual content at the second size includes:
in accordance with a determination that a gaze of the user was directed to a first portion of the first visual content while the position and/or orientation of the user of the electronic device changed, causing display of a portion of the first visual content including the first portion with a second scale different from the first scale; and
in accordance with a determination that the gaze of the user was directed to a second portion of the first visual content different from the first portion while the position and/or orientation of the user of the electronic device changed, causing display of a portion of the first visual content including the second portion with the second scale different from the first scale.
